(19) United States
(12) Patent Application Publication
(10) Pub. No.: US 2002/0143872 A1
(43) Pub. Date: Oct. 3, 2002

(54) Multiple service management platform utilizing common directory

(76) Inventors: Jeffrey Weiss, McKinney, TX (US); Jeffrey S. Hicks, Carrollton, TX (US); Terry L. Sigle, Allen, TX (US); Jason E. Steele, Plano, TX (US)

Correspondence Address: Raymond B. Churchill, Jr., Gottlieb, Rackman & Reisman, P.C., 270 Madison Avenue, New York, NY, 10016-0601, US

(21) Appl. No.: 09/818,012

(22) Filed: Mar. 27, 2001

(51) Int. Cl. G06F 15/16; G09G 5/00; H04L 12/16; H04Q 11/00

(52) U.S. Cl. 709/204; 345/733; 370/260

(57) ABSTRACT

A method and system for managing access and configuration of multiple independent communication related application services. The work associated with redundant configuration data or provisioning data necessary for managing the application services is minimized though a common directory server. The system utilizes a control module application having a common interface for modifying and entering duplicate data as well as data peculiar to each independent service.

### FIELD OF THE INVENTION

This invention relates to methods and systems for managing access to multiple communications related services or service applications by remote clients or customers over open networks. More specifically, the invention involves a method and system for management of communication related services and applications to simplify the administration and control of access thereto by multiple remote clients.

### BACKGROUND OF THE INVENTION

As a result of growing global connectivity using open networks such as the Internet, the provision of communication related services to small numbers of customers on a localized basis is not a viable option. Rather, to remain successful in such an environment, a communications service provider must provision itself to compete on a far broader scale. Moreover, with increasing technological advancements and ultimately the technological sophistication of consumers, the communications service provider must be prepared to offer a broader range of services.

However, there is no readily available way of meeting these joint business needs. Most manufacturers sell the technology on which a service provider's services are based as independent devices or applications. For example, telephone conferencing servers, electronic mail (email) servers, and virtual private network (VPN) servers are available as independent devices. Each service or service application has a unique provisioning interface and a unique database or data store. Maintaining these services using the distinct interfaces and the distinct databases is not an efficient way for a service provider to manage multiple services, especially for an extended or global customer base.

For example, consider a service provider wishing to offer an electronic mail service and a telephone conferencing service to multiple companies each having multiple users over an open network such as the Internet. With regard to the service systems, the service provider would acquire the technology infrastructure for each system and provision or maintain and configure each system separately with its own data store. Thus, when a new customer or company is added, the user profiles for each user of each company need to be configured for each service's system. These profiles might include, for example, contact information such as company, name, address and phone numbers, email address and some form of user credentials, such as, group names, usernames and passwords. The profiles may also include additional unique technical information specifically relating to each service. Some or all of the data in any single user's profile might be duplicated for each service. Thus, a technology infrastructure using both the electronic mail service and the teleconferencing service requires redundant data storage.

Unfortunately, redundant maintenance effort is the natural result of redundant data storage. As changes to user profiles are made, each affected system needs to be reconfigured or provisioned using each system's provisioning interface. This results in an unnecessary duplication of effort. It also requires personnel to be trained to use the interfaces of multiple systems. As one might expect, when additional services are added, the maintenance effort required for the additional services only increases since data redundancy also increases. In addition to these maintenance efforts, user changes and additions also require administration of an internal business nature. Changes in services to customers require billing systems updates to properly maintain the income flow of the business.

With all this necessary effort to keep up with customers'demands, it is apparent that a centralized and organized workflow would be highly advantageous. In the absence of such organization, a service provider is at risk of losing customers as it fails to keep up with its customers' expectations.

### BRIEF DESCRIPTION OF THE INVENTION

An objective of the present invention is to provide an integrated management system for the provisioning of multiple communication-related services.

A further objective is to simplify and organize the administration of such services and applications when provided to an extended customer base.

A still further objective of the present invention is to provide an efficient method for controlling user access to multiple services or applications.

Another objective of the present invention is to maximize the use of existing services and systems without making substantial modifications.

Additional objectives will be apparent from the following description of the invention.

In its broadest sense, the present invention involves an Application Management System (AMS) for communication related services. The AMS is useful for management and delivery of multiple communication related services over an open network such as the Internet. Generally, the AMS provides (1) a mechanism for provisioning of multiple application services, and (2) a mechanism for managing the orderly business related administration of the application services. Consistent with a business oriented model, the AMS is organized to manage services that are offered to multiple site locations or buildings having one or more companies which may be further subcategorized into users for each company. The services may include, for example, video broadcasting, voice/video teleconferencing, electronic mail, remote virtual private networking, user-personalized information access (custom portals) and Internet dialup access. Additional services may be added to the system as the service provider offers those services.

To accommodate the management of multiple services while minimizing effort duplication, the AMS system uses a centralized or common data store. In the preferred embodiment, the common data store is implemented through combined use of one or more database servers and a directory server. In general, the database servers maintain business data pertaining to (1) an identification of the services that are offered by the service provider, (2) an identification of the services that are available in different localities, (3) company contact information, (4) an identification of the services that are authorized by each company for its users, and (5) related billing information. The directory server manages provisioning data such as the user profiles containing the preference and access data necessary for each service.

The AMS system also utilizes an independent control module providing a centralized provisioning interface. With the interface, common data for any user need only be entered a single time. The control module then implements the necessary automated provisioning of all affected service systems. Since users are organized by company, multiple users may be provisioned simultaneously as a company. When automated provisioning of certain services is not possible, the AMS organizes work management to initiate and confirm that necessary system provisioning is performed by appropriate personnel. Finally, with the successful completion of systems provisioning, the AMS will make the necessary adjustments to related systems to allow for proper services billing and notification of customers/users as well pertinent service provider personnel.

### BRIEF DESCRIPTION OF THE DRAWINGS

FIG. 1 is a diagram showing a basic embodiment of the AMS system of the invention;

FIG. 2 is a diagram showing the preferred embodiment of the present invention;

FIG. 3 is a flow chart showing the interrelation between the control module and related external systems of the AMS system;

FIG. 4 is a diagram showing one embodiment of the invention in a networked system of communication related services;

FIG. 5 is a flow diagram showing the process for provisioning users;

FIG. 6 is an interface of the present invention for selecting a company;

FIG. 7 is an interface of the present invention for showing a list of companies;

FIG. 8 is an interface of the present invention for showing a company's locations and services for each location;

FIG. 9 is an interface of the present invention for showing a list of orders or quotes for a company;

FIG. 10 is an interface of the present invention for showing the details of a quote;

FIG. 11 is an interface of the present invention for showing a list of users for a company;

FIG. 12 is an interface of the present invention for showing the adding of a new user for a company;

FIG. 13 is an interface of the present invention for showing the adding of a group of new users for a company;

FIG. 14 is an interface of the present invention for selecting a user from a company;

FIG. 15 is a further interface of the present invention for selecting a user from a company;

FIG. 16 is an interface of the present invention showing some common provisioning data from a user profile;

FIG. 17 is an interface of the present invention for subscribing a user to one or more application services;

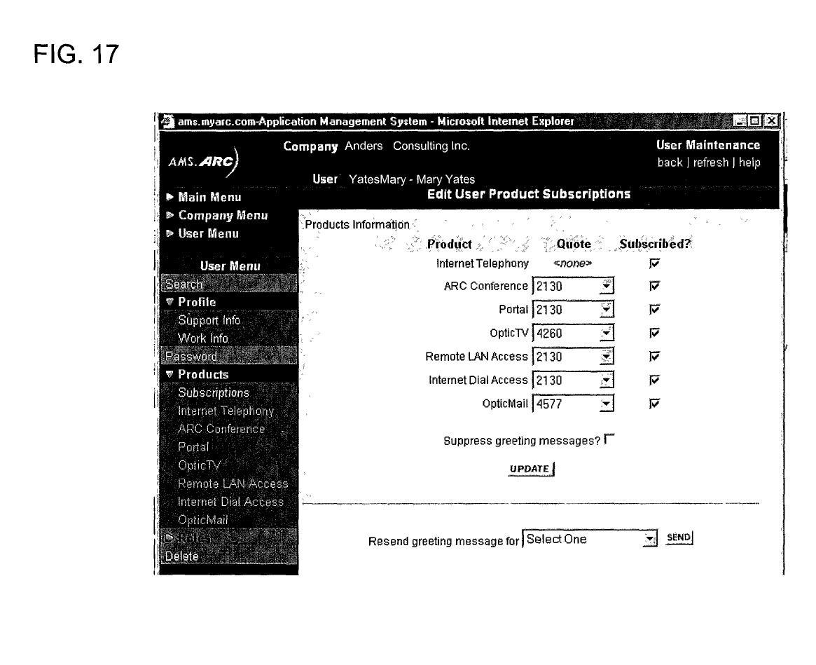

FIG. 18 is an interface of the present invention showing provisioning data from a particular application service for a single user; and

FIG. 19 is an interface of the present invention showing provisioning data from a particular application service for a company of users;

### DETAILED DESCRIPTION OF THE INVENTION

The following terms as used throughout this specification have the following meanings:

LAN refers to a local area network. A local area network is a connected group of electronic devices or computers at a single location such as a building or office. A LAN typically utilizes networking devices such as Ethernet and Token Ring circuits.

Open Network is a communications network connecting multiple LANs where the open Network is generally accessible to the public at large. An Open Network generally uses a common information transfer protocol. One such Open Network is the global Internet, which uses the TCP/IP protocol.

MPOP refers to a metropolitan point of presence. A metropolitan point of presence is a network location having a bank of connections for dial-up access by one or more independent communications devices, computers or LANs. Alternatively, a MPOP may utilize a bank of direct line access connections such as optical fibers, coaxial cable or an equivalent. A MPOP may also provide a combination of dial-up and direct access methods. Typically, a MPOP is also connected to an Open Network.

A Database Server is a service on an electronic device or computer used to store searchable indexed information that is commonly accessed through queries and includes, for example, a SQL server.

A Directory Server is a type of Database Server that provides particular methods for naming, managing and accessing collections of attribute value pairs stored in a hierarchical manner. These collections are commonly accessed through binding. One example of a Directory Server uses the Lightweight Directory Access Protocol (LDAP) and is accessible using a standard applications programming interface (API).

A User Portal is a dynamic electronic document or web page available over a network to a specific user which contains customizable information for the user including, for example, email messages, stock quotes, electronic maps and directions, news headlines, company specific news or announcements, company employee search tools, telephone conferencing tools, and/or a video/audio viewer.

A Service Application is a configurable communications related service that is offered to networked clients or users where the service is controlled by access credentials and/or preferences or settings associated with the particular client or user gaining access to the service. Examples of such services include video broadcasting, voice/video telephony, voice/video conferencing, electronic mail, remote virtual private networking, User Portal and Internet dialup access. For purposes of this specification, Service Application is also referred to as a Service.

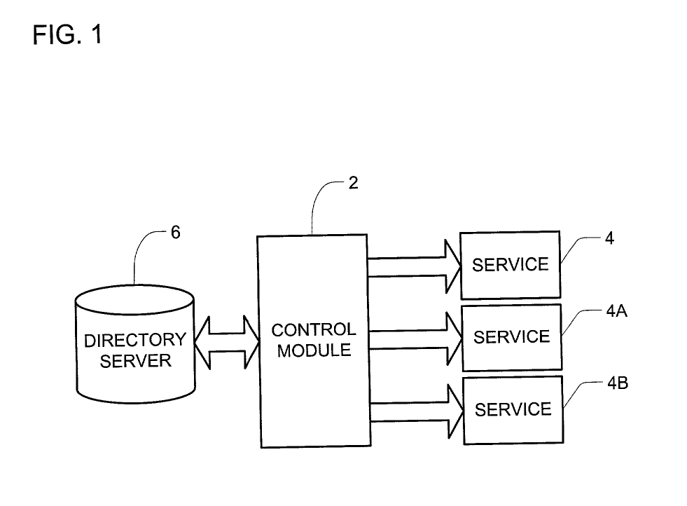

FIG. 1 depicts a simplified embodiment of the present invention. The invention generally involves an independent or centralized control module 2, two or more Services 4, 4A, 4B and a common Directory Server 6. Generally, the control module 2, is a software application providing a set of user interfaces, as well as the associated back-end functionality, used for provisioning or configuring Services 4, 4A and 4B. These interfaces include a common interface used for provisioning data common to all services. Thus, the common interface may include user profile information including company name, user address, user phone number, user email address, a password and username or userid, a group name, a classification, role or security level etc. Additional interfaces are used for Services 4, 4A, 4B as required for provisioning data not addressed in the common interface.

This control module 2 manages the provisioning data in a common Directory Server 6 and synchronizes the provisioning data in the data stores of Services 4, 4A, 4B. Through this use of the common Directory Server 6, the control module 2 is able to organize the efficient provisioning of Services 4, 4A, 4B. For example, it allows the use of common access credentials, such as a common username and password, for all of the multiple Services 4, 4A, 4B rather than separate usernames and passwords for each. As such, the username and password may be conveniently entered or modified for all Services 4, 4A, 4B in one place without duplication of effort.

The control module 2 is implemented in a programming language appropriate for cross-platform operation over a network connected by computers that may be running different operating systems. In the preferred embodiment, the JAVA programming language is utilized with the interface portions implemented as one or more servlets running on a web server. The servlets generate messages in a mark-up language viewable by a standard browser across a network to maximize access by users at remote locations. Thus, the control module 2 is a set of computer instructions in a computer readable medium for execution by a computer or server having one or more central processing units.

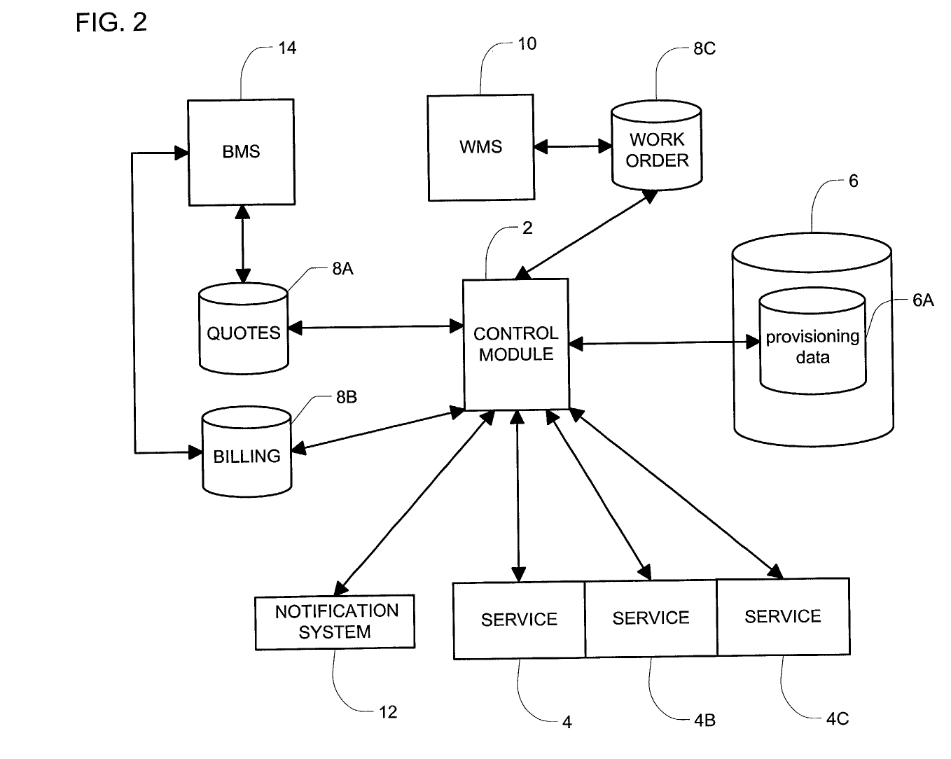

FIG. 2, shows the preferred embodiment of a system of the present invention. The system of FIG. 2 is based upon the embodiment of FIG. 1 with the Directory Server 6 illustrated as containing provisioning data 6A. However, the system incorporates additional optional elements including business data. The business data includes, for example, Quote data 8A and Billing data 8B. Business data may also include information pertaining to the services that are offered by the service provider (not shown). Optionally, the business data may include data particular to companies of users such as, for example, an identification of the services that have been authorized by the company, company contact information and location information (not shown). In FIG. 2, the business data may be stored in a Database Server or in multiple Database Servers or database files that are associated with a particular system developed to manage such data.

Additional optional elements of the system of FIG. 2 include a Work Management System 10. Generally, the Work Management System 10 is used for initiating and confirming that any necessary physical provisioning of the Services 4, 4A, 4B by service provider personnel will be accomplished in an efficient and organized manner. This is accomplished using shared or exchanged Work Order data 8C. Work Order data 8C may be stored in a Database Server or database files that are associated with the Work Management System 10 developed to manage such data. In the preferred embodiment of the system, the Work Management System is the “InConcert” work management application from TIBCO Software Inc.

The system also incorporates a Business Management System 12. The Business Management System 12 may be used for processing business data including Quote data 8A and Billing data 8B, which may be accessed or created by control module 2. The Business Management Systems 12 may be a single system or multiple systems provided that the control module 2 may access the appropriate business data within each system. In the preferred embodiment of the invention, the Business Management System 12 is implemented with the “Infranet” billing application from Portal Software, Inc. and the “CRM” sales and quote/order entry application from Vantive Corp. (now People Soft, Inc.).

A Notification System 12 may also be used. The Notification System 12 is used to notify users and personnel of changes made through the control module 2. In the preferred embodiment, the Notification System 12 is an email server.

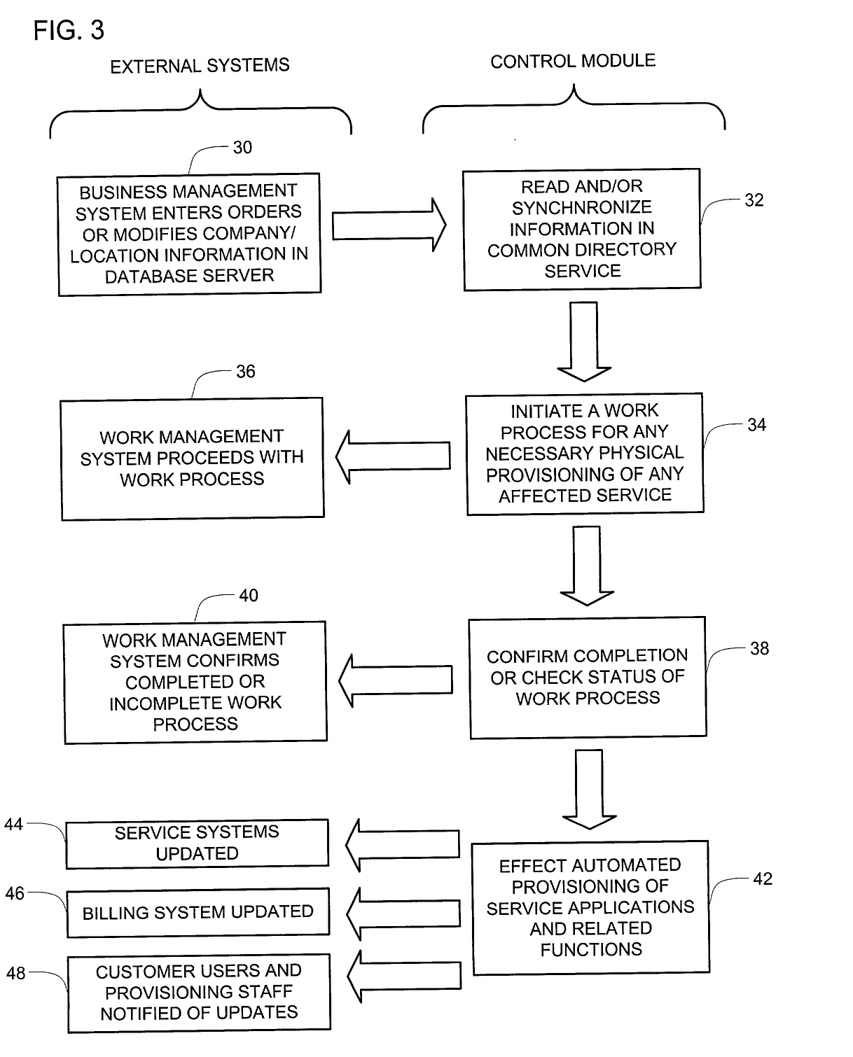

The benefits of this system if not immediately apparent will be clearer by examining the process flow of FIG. 3 with regard to a customer request that requires service provisioning. In this regard, FIG. 3 depicts the interaction between the control module 2 and external systems including the Work Management System 10, the Notification System 12, and Business Management System 14. In step 30, the Business Management System 12 creates an order or Quote data 8A by entering business data in a database shared with the control module 2. The Quote data 8A contains information relating to a modification or addition of services for a new or existing customer or company. In step 32, the control module 2 reads business data or new Quote data 8A from the database and modifies or creates appropriate provisioning data in the Directory Server 6.

In step 34, the control module 2 then triggers a work process, through interaction with Work Management System 10, to initiate the physical work relating to the provisioning of Services 4, 4A, 4B affected by the Quote data 8A. The control module 2 determines whether physical work must take place and, if so, it creates Work Order data 8C in a database shared with the Work Management System 10. In step 36, the Work Management System 10 directs the assignment of appropriate personnel and monitors performance and completion of any required physical provisioning based upon the Work Order data 8C. In step 38, the control module 2 interacts with the Work Management System 10 to confirm completion of the provisioning required by the Work Order data 6A. In step 40, the Work Management System 10 confirms whether required work has been completed.

In step 42, the control module 2 completes all automated provisioning of Services 4, 4A and 4B and related functions. To this end, in step 44, the control module 2 interacts with Services 4, 4A, 4B as required by Quote data 6A, to accomplish provisioning functions that do not need to be performed through the Work Management System 10 in step 36. This automated provisioning may include the synchronization or creation of provisioning data stored within the data structures or databases of Services 4, 4A, 4B.

In step 46, the control module 2 generates billing information for use by Business Management System 10. To this end, the control module 2 creates Billing data 8B in a database shared with Business Management System 10. Finally, the control module 2 interacts with the Notification System 12 to generate messages to be sent to all people affected by the provisioning changes. Thus, in step 48 messages are sent to users who are provided with information concerning the new services that have been provisioned. In addition, messages will be sent to internal service provider personnel to notify them of the provisioning changes. In the preferred embodiment, the Notification System 12 is an electronic mail server.

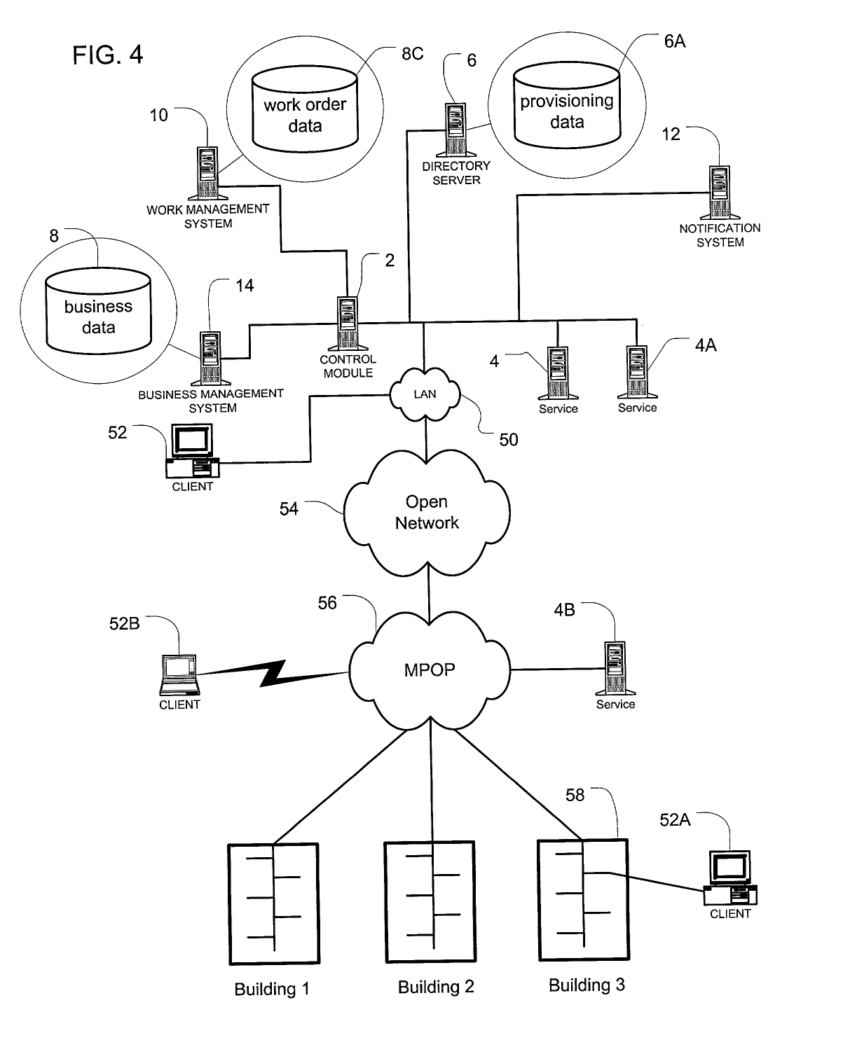

FIG. 4 illustrates one network configuration implementing the system of the present invention. Control module 2, running on a server, is part of a LAN 50. The Control module 2 using a communication port or networking device may access Directory Server 6 for provisioning data 6A, Work Management System 10 for Work Order data 8C, Business Management System 14 for business data 8, Notification System 12 and Services 4, 4A, 4B through any available network communications protocol. Client 52, 52A may use the interface generated by control module 2 to provision Services 4, 4A, 4B. As illustrated in FIG. 4, Client 52 accesses control module 2 over LAN 50. Alternatively, Client 52A accesses control module 2 from a remote site location 58 linked with MPOP 56 over an Open Network 54. In a further alternative, Client 52B accesses control module 2 using a wireless device such as a wireless phone or other portable Internet access device. Individuals skilled in the field will readily recognize that many alternative network configurations may be implemented without deviating from the principles of the invention.

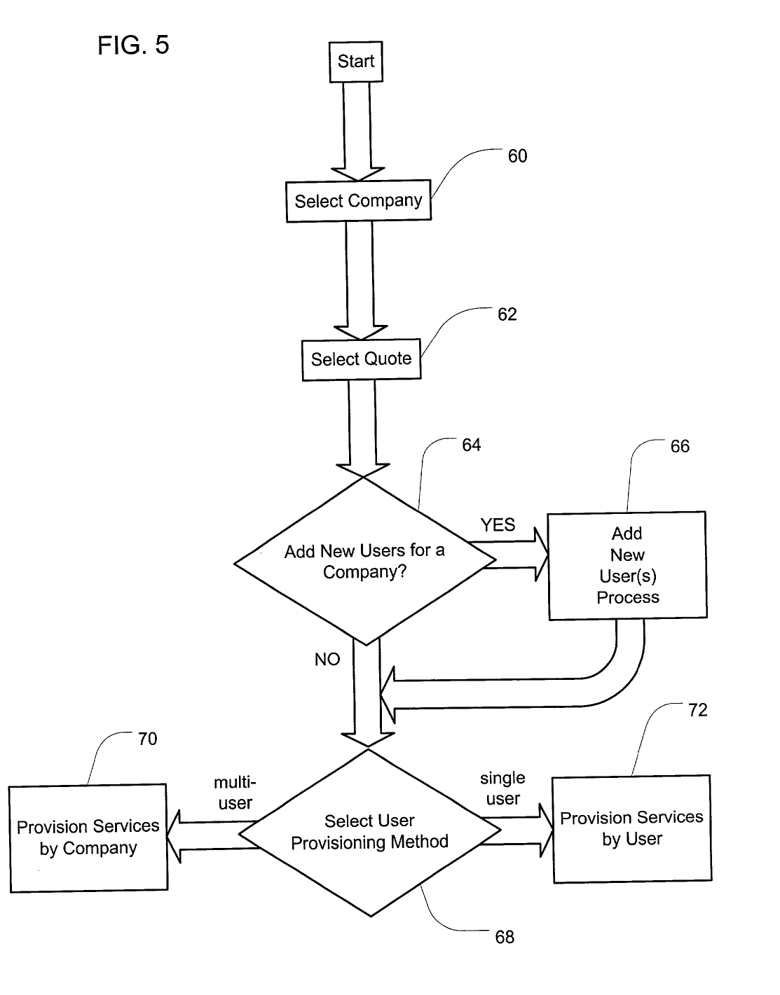

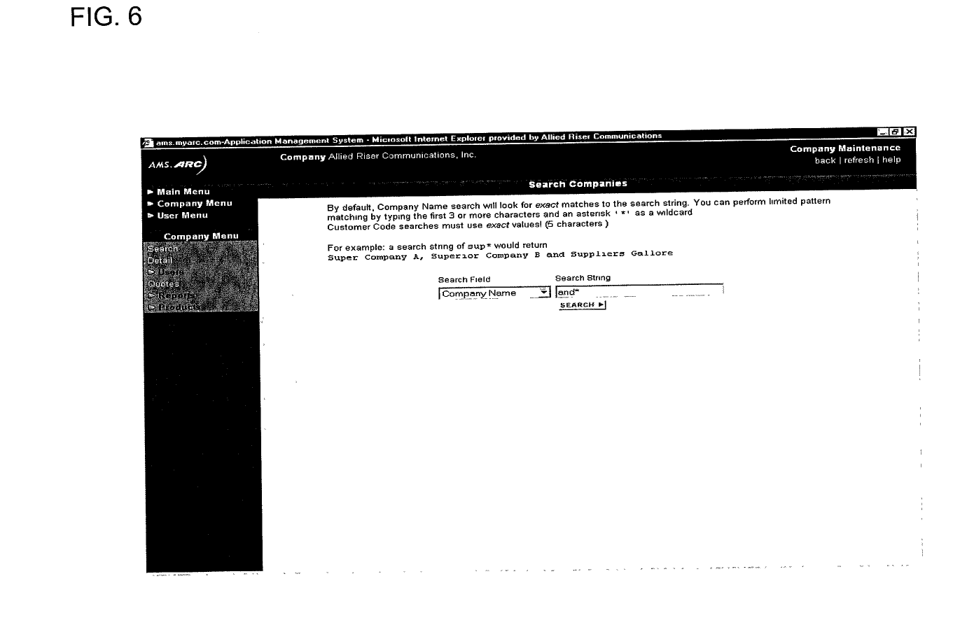

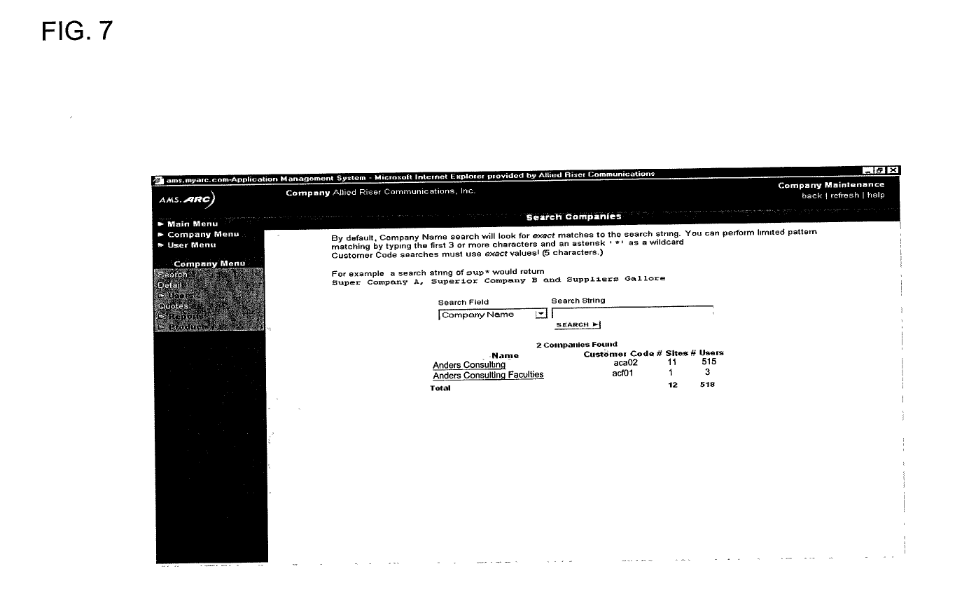

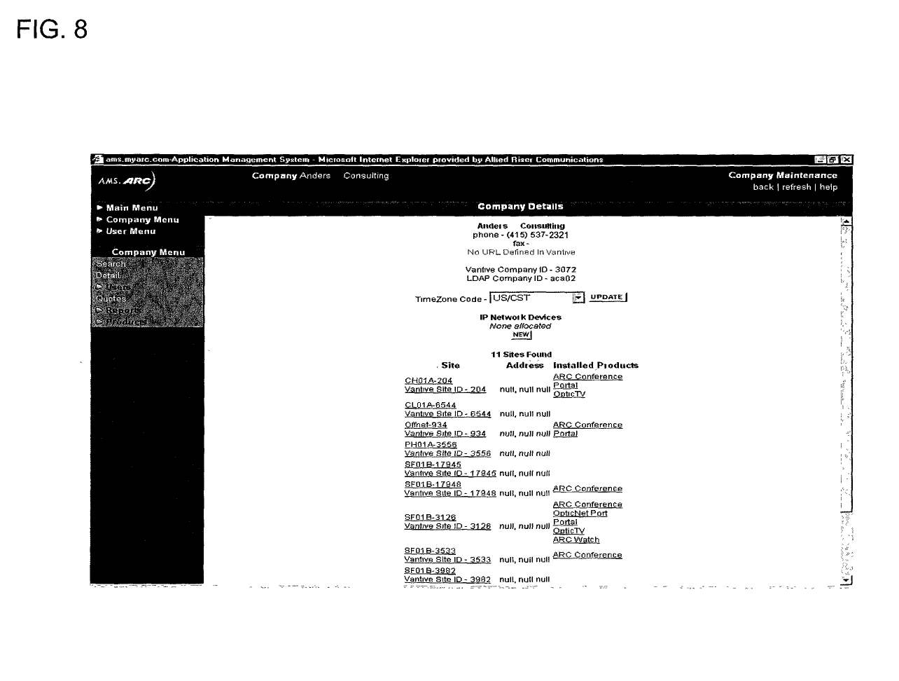

In FIG. 5, the process flow of a Client 52, 52A, 52B using control module 2 to provision new Services 4, 4A, 4B is detailed. Upon entering the process, the Client 52, 52A, 52B, through a user interface shown in FIG. 6 selects a company shown in step 60. This selection process will typically involve a search for a particular company. The results of one such search are depicted in the user interface of FIG. 7. The selection of a company in step 60, may further include the selection of a particular location for companies having multiple locations. The user interface of FIG. 8 illustrates multiple location details for a particular company.

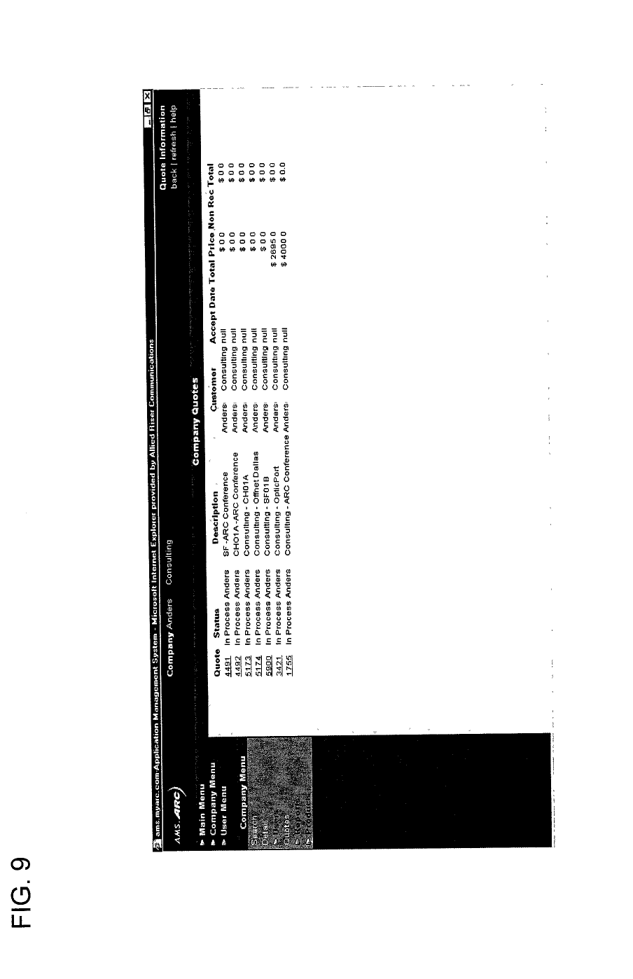

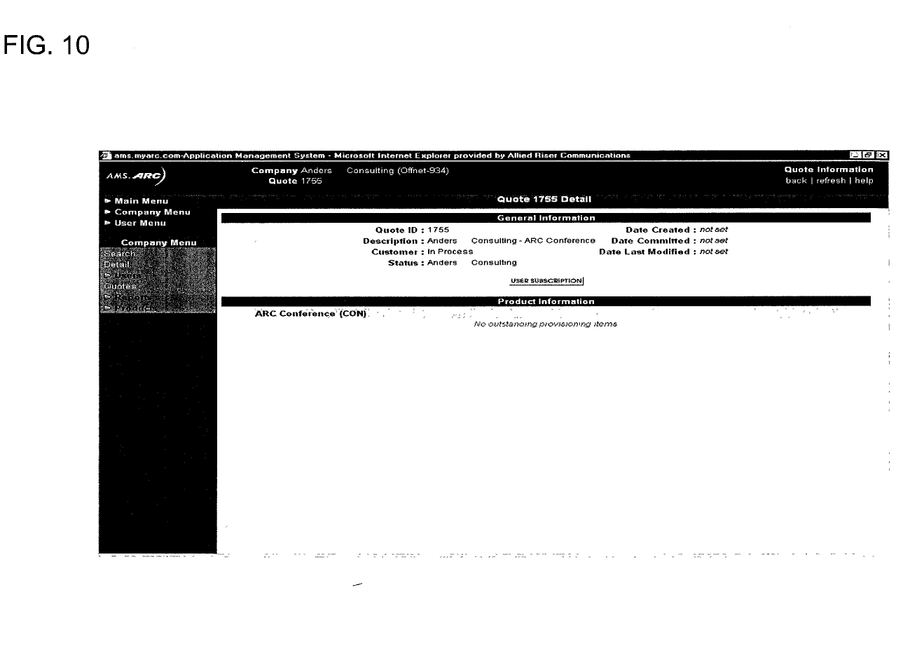

In step 62, once an appropriate company or location is selected, the Client 52, 52A, 52B selects a quote or order relating to the company selected. FIG. 9 illustrates an interface for selecting quotes and FIG. 10 illustrates an interface showing the details of a selected quote.

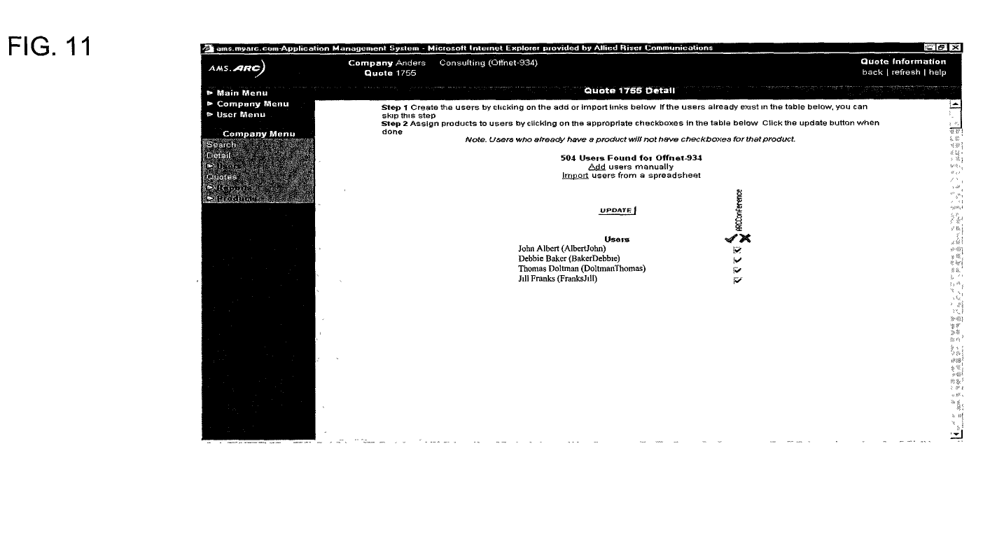

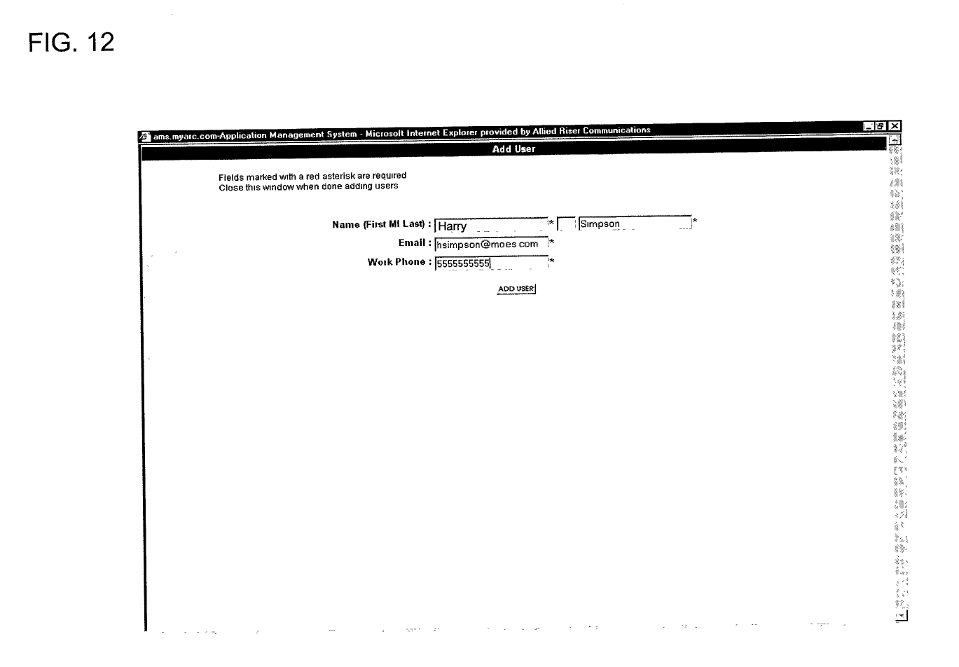

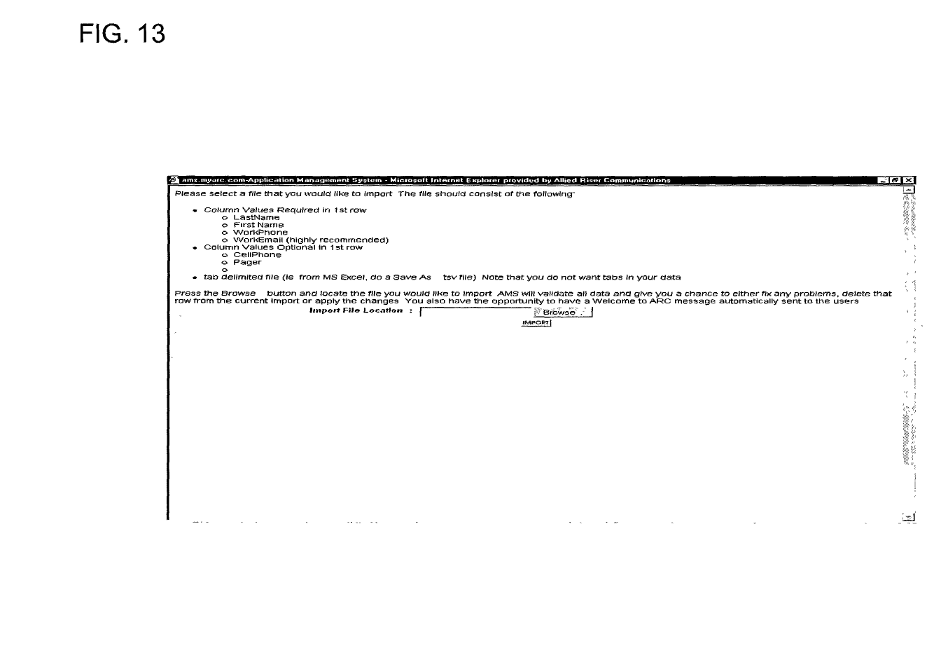

In step 64, the Client 52, 52A, 52B decides whether new users will be added for the selected company. FIG. 11 illustrates an interface with multiple users for a company. If users will be added, in step 66, the Client 52, 52A, 52B may add users individually or import multiple users simultaneously from a data file. FIG. 12 depicts an interface showing users being added individually. FIG. 13 illustrates an interface for importing multiple users from a data file. In this step, common provisioning data is entered once so that it may be used by two or more Services 4, 4A, 4B.

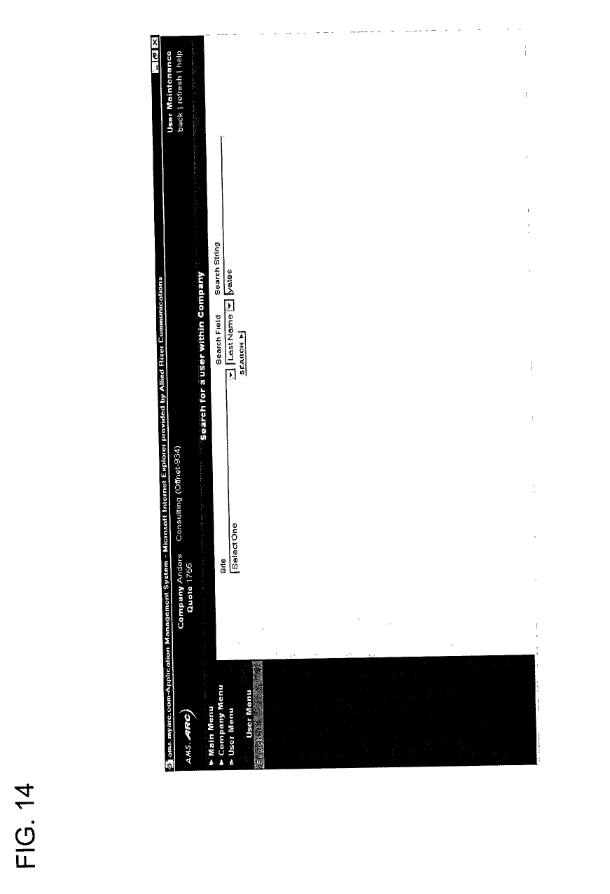

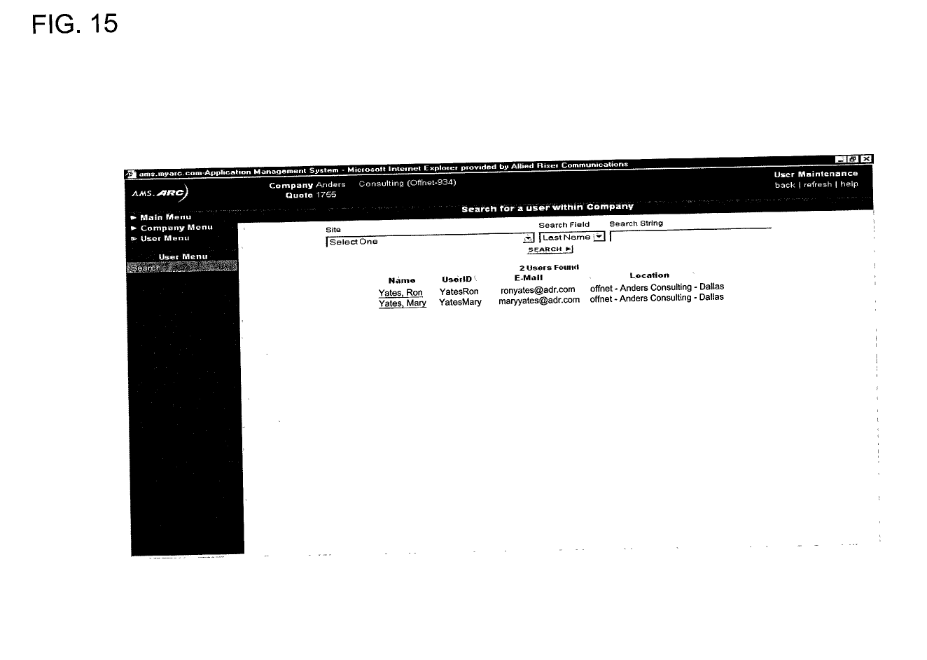

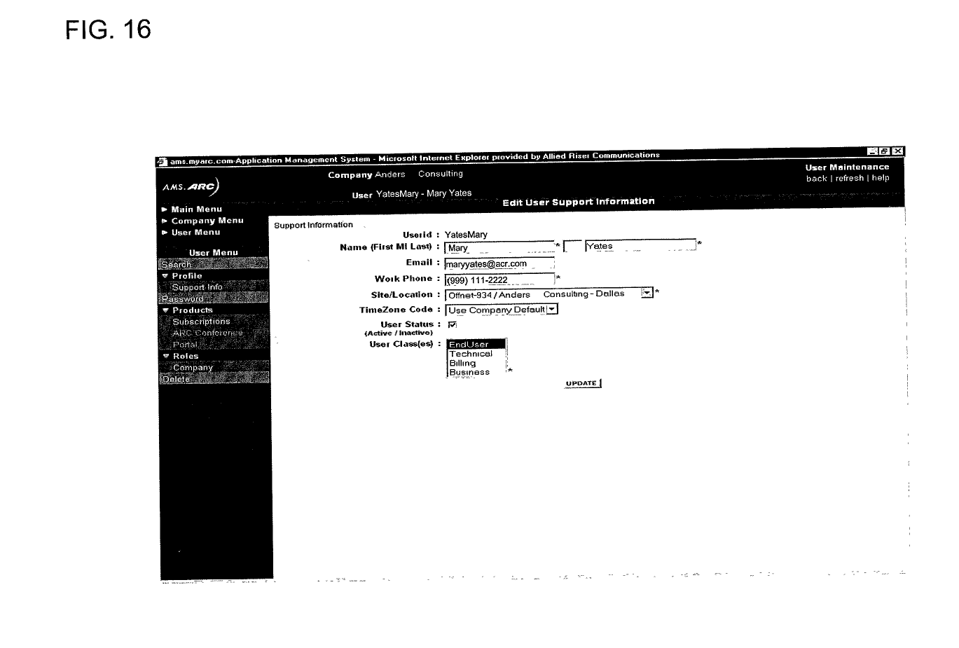

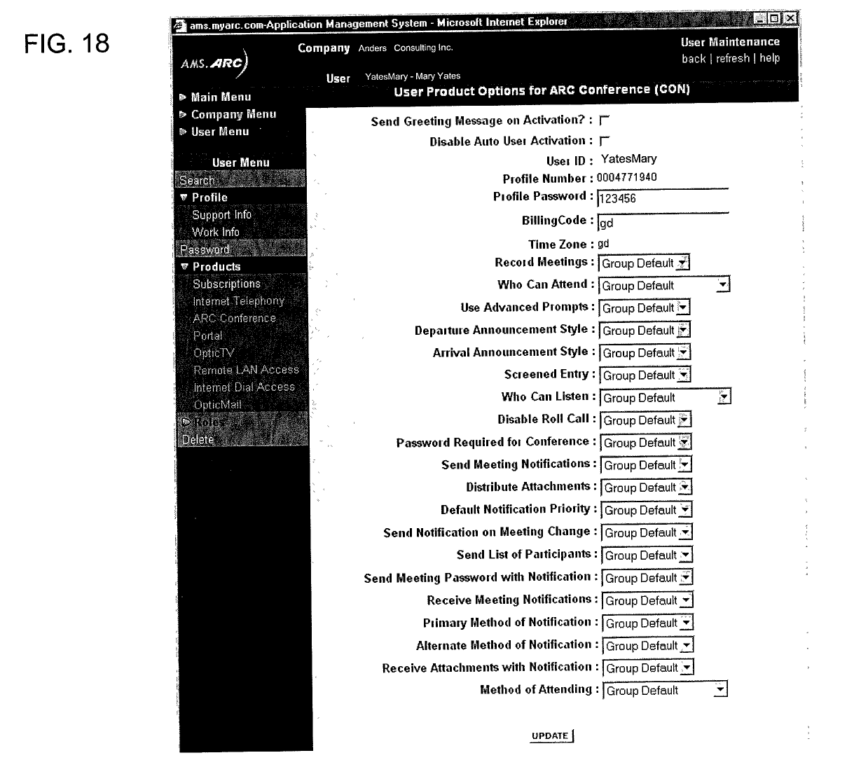

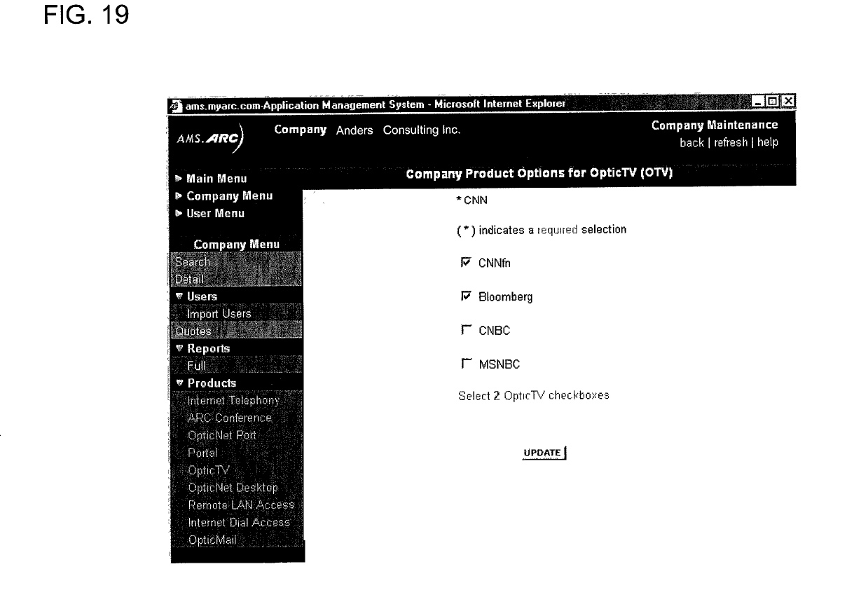

In step 68, the Client 52, 52A, 52B decides whether to configure users individually or alternatively by company as a whole. If a single user is configured, in step 72, the Client 52, 52A, 52B may search for a particular user. An interface for this search is depicted in FIG. 14. The results of one such user search are depicted in FIG. 15. Once a user is selected, user profile data may be modified for the user including contact information, user classifications, passwords, etc. In FIG. 16 an interface for modifying user information is illustrated. The configuration of the services offered to the user may also be modified or provisioned. FIG. 18 illustrates one interface for the provisioning of a conferencing service. In step 70, if all users from a company are provisioned, default values are modified as in step 72. In this regard, FIG. 19 illustrates one provisioning interface to provision a company of users for a video delivery service.

While FIG. 18 shows an interface for provisioning a conferencing service, it is easy to see that additional such interfaces may be added for additional services that are provisioned from the control module 2. For example, the service provider might provide a User Portal service. Given the diversity of integrated application services relating to the User Portal, a provisioning interface will be required for each integrated application service. Thus, a provisioning interface may contain preferences or provisioning data for a weather service, a mapping service, a stock service, an announcement service, a calendar service, an audio/video viewing service, an employee locator service, a training service, a virtual private network service, and an intranet information service. However, the data required for additional interfaces is minimized since redundant or common provisioning data need not be entered.

Using the methods and principles of the present invention, it will be apparent that changes in the service requirements of a company or a user from a company may be effected by end users themselves. This user provisioning would minimize or eliminate the responsibilities of service provider personnel. Depending upon the role or classification assigned to a particular company user as contained in the user's profile, a company user located at Client 52A might be responsible for making provisional changes for services for himself or for all users for the particular company or the particular site location of the company.

Utilizing the system of the present invention, the service provider is not limited to the use of service applications or services provided by a common developer. For example, in the an embodiment of the present invention, services include an e-mail service provided by Critical Path, Inc., a audio conferencing server provided by Latitude Communications, Inc., and an audio/video service using an IP/TV server provided by Cisco Systems, Inc. The services may also include a virtual private network service using virtual private network (VPN) devices. The common control of virtual private network devices is the subject of a commonly assigned patent application entitled “Method And System for Common Control of Virtual Private Network Devices,” Serial No. ______ filed on even day herewith. The subject matter of the foregoing application is hereby incorporated by reference. Through the use of an independent control, independent from any particular service, a service provider is permitted to select the technology for each class of service that may be offered regardless of the developer.

Although the invention has been described with reference to various embodiments, it is to be understood that these embodiments are merely illustrative of an application of the principles of the invention. Numerous modifications in the illustrative embodiments of the invention may be made and other arrangements may be devised without departing from the spirit and scope of the invention.

1. A computerized system for the provisioning of multiple application services for a communications related service provider comprising:
an independent control module application on a server with a common interface and a plurality of provisioning interfaces;
a plurality of independent service applications each with a data store used for control of one said service applications; and
a common directory server; wherein said common interface is used to modify or create common provisioning data stored in said common directory server; said provisioning interfaces are used to modify or create unique provisioning data stored in said common directory server; and said control module application generates or synchronizes the data stores of said service applications with said common and unique provisioning data in said directory server for control of said service applications.

2. The computerized system of claim 1 wherein said directory server organizes users by company name to allow said control module application to make changes to the services of all users of a particular company by making changes in the data of said particular company.

3. The computerized system of claim 1 wherein said common provisioning data comprises one username and password for each user of said service applications.

4. The computerized system of claim 3 wherein said common provisioning data includes a company name.

5. The computerized system of claim 3 wherein said common provisioning data includes user contact information.

6. The computerized system of claim 1 further comprising a work management system and an associated work management database wherein said control module communicates with said work management database to access and modify work order data to initiate and confirm completion of provisioning of said service applications.

7. The computerized system of claim 1 or 6 further comprising a business management system and an associated business management database wherein said control module communicates with said business management database to access and modify business data maintained by said business management system in said database.

8. The computerized system of claim 7 wherein said business data includes quotes for use of said service applications.

9. The computerized system of claim 8 wherein said business data further includes billing information for use of said service applications.

10. The computerized system of claim 9 wherein said business data further comprises company names, locations, and which of said services are available at said locations.

11. The computerized system of claim 7 further including a notification system wherein said control module communicates with said notification system to notify users of the provisioning of said service applications.

12. The computerized system of claim 11 wherein one of said service applications is an electronic mail service.

13. The computerized system of claim 11 wherein one of said service applications is a conferencing service.

14. The computerized system of claim 11 wherein one of said service applications is a video delivery service.

15. The computerized system of claim 11 wherein one of said service applications is a user portal service.

16. The computerized system of claim 11 wherein one of said service applications is a virtual private network service.

17. The computerized system of claim 11 wherein one of said service applications is an Internet dialup access service.

18. A computerized apparatus for the provisioning of multiple application services for a communications related service provider comprising:
a processor;
a computer-readable medium operatively coupled to the processor and storing instructions; and
a communications device operatively coupled to the processor, wherein said instructions cause the processor to
(a) display a common interface and a plurality of provisioning interfaces;
(b) receive through said communications device provisioning data maintained in a common external directory server;
(c) transmit through said communications device provisioning data entered or modified with said common interface and provisioning interfaces in a protocol readable by said common external directory server; and
(d) transmit through said communications device provisioning data from said external directory server or said common interface or provisioning interfaces to a plurality of external data stores that are used for the control of a plurality of respective application services.

19. The computerized apparatus of claim 18 wherein said instructions further cause said processor to transmit through said communications device work management data to an external data store of a work management system based upon the provisioning data entered or modified with said provisioning interfaces.

20. The computerized apparatus of claim 18 wherein said instructions further cause said processor to transmit through said communications device business data to an external data store of a business management system based upon the provisioning data entered or modified with said provisioning interfaces.

21. The computerized apparatus of claim 18 wherein said instructions further cause said processor to control transmission through said communications device an email message based upon the provisioning data entered or modified with said provisioning interfaces.

22. The computerized apparatus of claim 18 wherein said provisioning data includes a common username and common password for access to said service applications by a user.

23. The computerized apparatus of claim 22 wherein said provisioning data further includes a company name.

24. The computerized system of claim 22 wherein one of said service applications is an electronic mail service.

25. The computerized system of claim 22 wherein one of said service applications is a conferencing service.

26. The computerized system of claim 22 wherein one of said service applications is a video delivery service.

27. The computerized system of claim 22 wherein one of said service applications is a user portal service.

28. The computerized system of claim 22 wherein one of said service applications is a virtual private network service.

29. The computerized system of claim 22 wherein one of said service applications is an Internet dialup access service.

30. A computer readable medium with executable instructions for the provisioning of multiple application services for a communications related service provider, said instructions comprising:
generating a common interface and a plurality of provisioning interfaces for provisioning data used for access to and control of a plurality of independent application services;
transmitting provisioning data from said common interface and said provisioning interfaces for storage in a directory server; and
transmitting provisioning data from said directory server to external data stores of said plurality of independent application services.

31. The computer readable medium with executable instructions of claim 30 with further instructions controlling:
transmitting device work management data to an external data store of a work management system based upon the provisioning data entered or modified with said provisioning interfaces.

32. The computer readable medium with executable instructions of claim 31 with further instructions controlling:
transmitting business data to an external data store of a business management system based upon the provisioning data entered or modified with said provisioning interfaces.

33. The computer readable medium with executable instructions of claim 32 with further instructions controlling:
transmitting through a communications device an email message based upon the provisioning data entered or modified with said provisioning interfaces.

34. The computerized apparatus of claim 33 wherein said provisioning data includes a common username and common password for access to said service applications by a user.

35. The computerized apparatus of claim 34 wherein said provisioning data further includes a company name.

36. The computerized system of claim 34 wherein one of said service applications is an electronic mail service.

37. The computerized system of claim 34 wherein one of said service applications is a conferencing service.

38. The computerized system of claim 34 wherein one of said service applications is a video delivery service.

39. The computerized system of claim 34 wherein one of said service applications is a user portal service.

40. The computerized system of claim 34 wherein one of said service applications is a virtual private network service.

41. The computerized system of claim 34 wherein one of said service applications is an Internet dialup access service.

42. A method for the provisioning of multiple application services for a communications related service provider comprising the steps of:
generating a common interface and a plurality of provisioning interfaces for provisioning data used for access to and control of a plurality of independent application services;
transmitting provisioning data from said common interface and said provisioning interfaces for storage in a directory server; and
transmitting provisioning data from said directory server to external data stores of said plurality of independent application services.

43. The method of claim 42 further comprising the step of:
transmitting work management data to an external data store of a work management system based upon the provisioning data entered or modified with said provisioning interfaces.

44. The method of claim 43 further comprising the step of:
transmitting business data to an external data store of a business management system based upon the provisioning data entered or modified with said provisioning interfaces.

45. The method of claim 44 further comprising the step of:
transmitting through a communications device an email message based upon the provisioning data entered or modified with said provisioning interfaces.

46. The method of claim 42 wherein said provisioning data includes a common username and common password for access to said service applications by a user.

47. The method of claim 43 wherein said provisioning data further includes a company name.

48. The method of claim 43 wherein one of said service applications is an electronic mail service.

49. The computerized system of claim 43 wherein one of said service applications is a conferencing service.

50. The computerized system of claim 43 wherein one of said service applications is a video delivery service.

51. The computerized system of claim 43 wherein one of said service applications is a user portal service.

52. The computerized system of claim 43 wherein one of said service applications is a virtual private network service.

53. The computerized system of claim 43 wherein one of said service applications is an Internet dialup access service.
